(19) United States
(12) Patent Application Publication
(10) Pub. No.: US 2016/0249598 A1
(43) Pub. Date: Sep. 1, 2016

(54) Mattress and Furniture Processor

(71) Applicant: Robert Savino, Greensboro, NC (US)

(72) Inventor: Robert Savino, Greensboro, NC (US)

(21) Appl. No.: 15/143,859

(22) Filed: May 2, 2016

(51) Int. Cl. A01M 13/00; A47L 11/40

(52) U.S. Cl. CPC A01M 13/003; A47L 11/405

(57) ABSTRACT

A portable mattress and upholstery processor, such as an inter-mobile shipping container, having a chamber constructed of side walls, a ceiling, and a floor; at least one door being located on a side wall and hingedly attached thereto to provide access to the chamber; guides joined to the floor of the chamber and running from the door to the wall opposite the door, the guides constructed to receive and direct casters; carts having casters for transport of mattresses and furniture to within the chamber; a heat source in convective thermal communication with the mattress or furniture within the chamber.

### FIELD OF THE INVENTION

The present invention relates to a device for eradicating pests and pathogens from mattresses and furniture through thermal processing and more particularly to a mobile and stackable device, such as art inter-mobile shipping container, for thermal processing of mattresses and furniture.

### BACKGROUND OF THE INVENTION

Pests, such as bed bugs, mites, spiders and the like, enter into mattresses and furniture overtime. The mattresses and furniture provide an environment in which they can seek out food, raise their young and hide from other predators. However nice this may be for the pests, humans prefer not to sleep in amid a nest of such critters.

Likewise pathogens can also enter into the fabrics of mattresses and furniture. Bacteria from people's bodies can be spread from person to person with the mattresses and furniture acting as a carrier. This problem is particularly acute in hotels and motels across the country. This has led to regulation of the handling of mattresses and furniture as well as the re-sale of such items. Previously, such items needed to be periodically disposed for obvious sanitary reasons.

Thermal processing of mattresses and furniture developed as a recycling effort Patent Application Publication to Baum (U.S. Publication No. 2007/0283986) discloses a portable furniture treatment system mounted in a truck trailer for removing insect pests such as bed bugs, mites and the like. Mattresses are placed into the device and heat treated.

Patent Application Publication to Topp (U.S. Publication No. 2004/0035044) and Patent Application Publication to Lindsay et al. (U.S. Patent No. 2007/0084105) are further examples inventions that thermally eradicate pests in the form of an intermodal shipping container.

While previous designs contemplate portable intermodal containers, the lifting and storage of such systems remains unaddressed. What is needed is tracks for lifting the intermodal containers with a fork lift and grooves in the upper portion of the containers for a stacked storage of containers one atop the other.

### SUMMARY OF THE INVENTION

The invention is a portable mattress and furniture processor having a chamber formed from side walls, a ceiling, and a floor. A door is located on a side wait of the enclosure and attached by way of hinges to provide access from outside the enclosure to the chamber. Guides are attached to the floor of the enclosure, running from the door to the opposite wall to receive and direct casters. A cart, having v-groove casters, is used to transport mattresses, furniture and the like from an area outside the enclosure into the chamber. A heat source is in convective thermal communication with the mattresses and furniture within the chamber for eradication of pests and mold spores. Tracks for lifting the intermodal containers with a fork lift and grooves fn the upper portion of the containers for a stacked storage of containers one atop the other.

Advantageously, the present invention provides a portable means to restore hygiene to mattresses and furniture.

As yet, a further advantage, the present invention provides use of tracks for lifting and stacking containers.

As still yet another advantage, tracks for lifting the intermodal containers with a forklift and mating grooves defined in the upper portion of the containers for a stacked storage of containers one atop the other.

These and other advantages will become clear through reading the following description with reference to the drawings.

### BRIEF DESCRIPTION OF THE DRAWINGS

FIG. 1 is a cross sectional view from the end of the portable mattress and furniture processor.

FIG. 2 is a perspective view partially in phantom through the doors to the interior of the portable mattress and furniture processor.

FIG. 3 is a perspective drawing showing the cart.

The figures show the preferred manner of making and using the present invention and are not to be read in a limiting manner.

### DESCRIPTION OF THE PREFERRED EMBODIMENT

The present invention is a portable mattress and furniture processor 10 having an inner chamber 20 and an outer chamber 30 constructed of at least one side wall 22,32, a ceiling 24, 34, and a floor 26, 36. The processor 10 may be in the form of an inter-mobile shipping container, be portable and stackable. The outer chamber 30 encloses the inner chamber 20. The chambers 20, 30 may be rectangular cube in shape or any other shape. Chamber 20 may be defined by side walls 22 and chamber 30 defined between walls 22,32. Brackets 40, such as L-brackets, are attached to the inner 22 and outer side wall 32 positioned in chamber 30 through the use of screws or other fasteners sufficient to hold the brackets 40 in place. Insulation 42 is located between outer chamber side wall 32 and inner chamber side wall 22 e.g. in outer chamber 30, and secured in place by the brackets 40. The inner chamber 20 may be constructed of 16-gauge stainless steel or galvanized metal, or any other sufficient material. Alternatively, the brackets 40 may be any other means sufficient to space the inner 22 and outer wall 32 and hold the insulation 42 in place. In alternative, the inner chamber 20 may be a single thickness of wall 22 with sufficient insulative properties, removing the benefit of outer chamber 30.

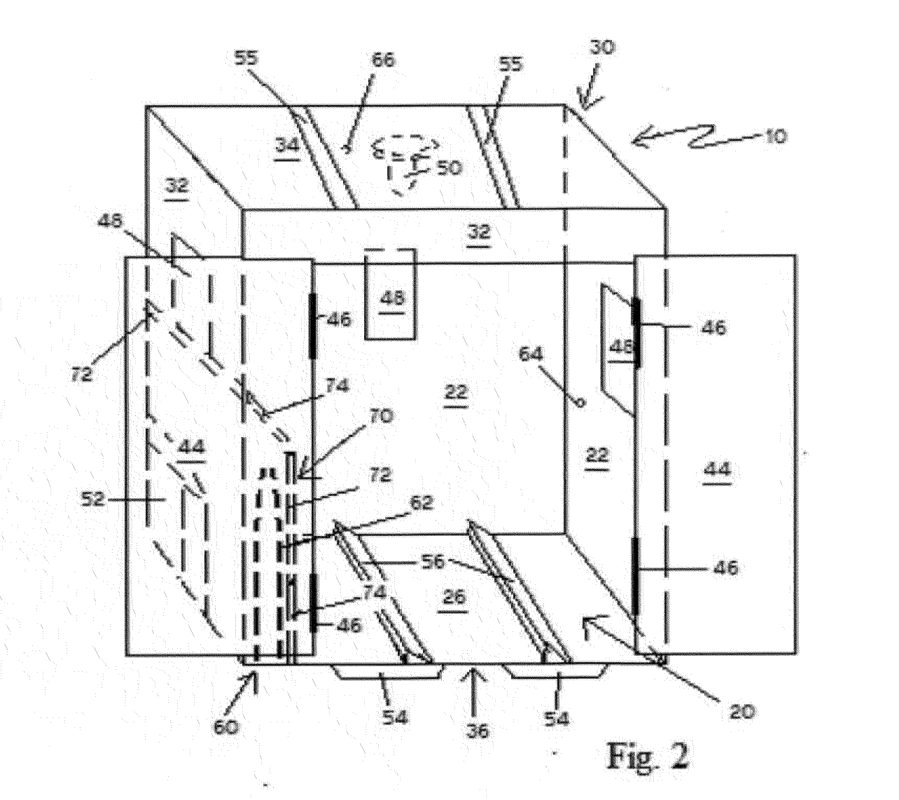

Referring to FIG. 2, at least one door 44 is located on at least one side wall 22, 32 by way of hinges 46. The doors 44 provide access from outside the processor 10 into the inner chamber 20. View ports 48 may be located on the side walls 22, 32 of the enclosure to provide visual access from outside the enclosure into the inner chamber 20. A light source 50 may be present to illuminate the inner chamber 20. The light source 50 may be one or more light bulbs, which may be in electrical communication with a generator 52, or the view ports 48, themselves, may be structured such as to allow sufficient exterior light to illuminate the interior space of the chamber 20. The generator 52 may be located within the chamber 30 or external thereto.

Tracks 54 may be joined to the floor of the outer chamber 36 to receive the forks of a forklift. This would allow for easy movement of the chamber 20, 30 through use of a forklift, lifting and stacking of processors 10. Tracks 54 may be sized and adapted to be received within grooves 55 defined in an upper surface of the processor 10 such that processors 10 may be securely stacked while in storage. That is, the tracks 54 of one processor 10 may be placed into the grooves 55 of another processor 10 such that the first processor 10 is stacked atop the second processor 10.

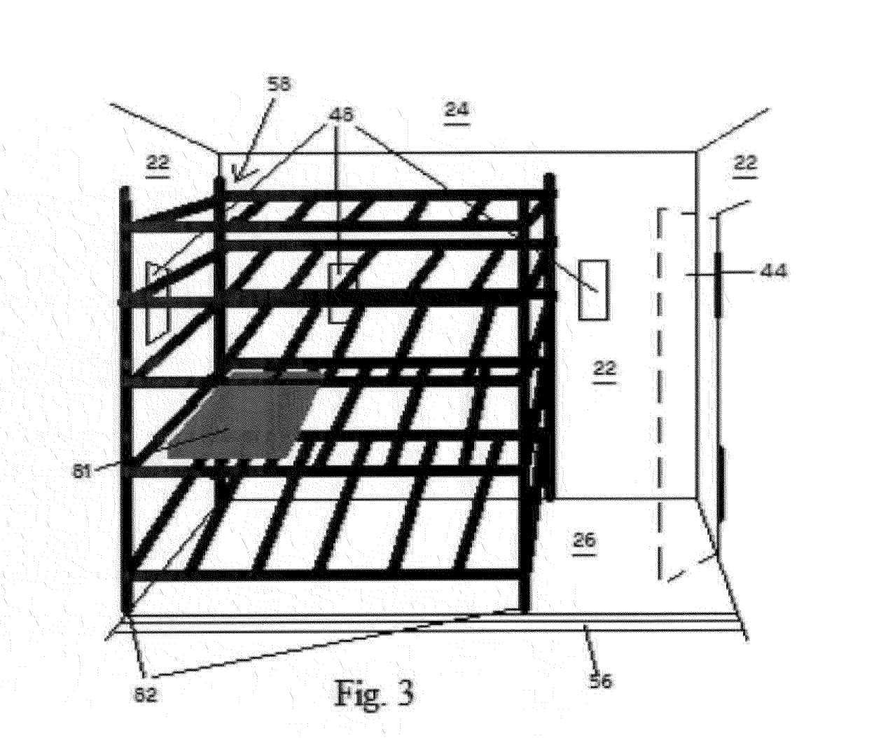

Raised angled guides 56, such as angle brackets, may be joined to the floor of the inner enclosure 26. The angles 56 may run from the doors 44 to the wall 22 opposite the doors 44. Other configurations of the angles 56 would also be possible. The angles 56 are sized, shaped and adapted to receive and guide v-groove casters 82 (FIG. 3). Carts 80 for transport of mattresses and furniture from outside the enclosure to the inner chamber 20 may be used. The carts 80 may have v-groove casters 82.

The carts 80 may have racks 58 sized, adapted and positioned to support mattresses 81 and furniture. The carts 80 may be selectively positioned within the inner chamber 20 for processing of mattresses and furniture. Spacing between the mattresses and furniture is such that thermal convection occurs between the mattresses and furniture.

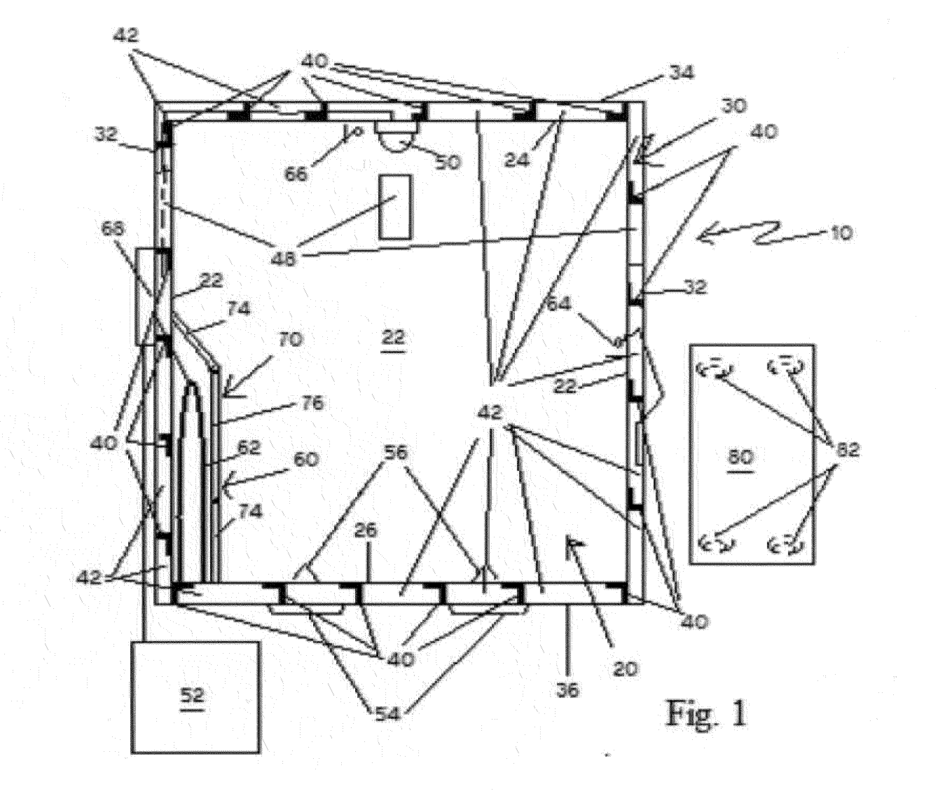

A heat source 60, such as a furnace, may tie located adjacent a side wall 22 within the inner chamber 20. See FIGS. 1 and 2. The heat source 60 is in convective thermal communication with the inner chamber 20. The furnace 60 may contain heating elements 62, thermocouples 64 for regulation of the temperature of the inner chamber 20, temperature probes 66 for emergency shut-off of the heat source at manufacturer determined temperatures sufficient to assure safety. A barrier wall 70 may be positioned adjacent to and enclosing the heat source 60. The barrier wall 70 is in connection with the inner chamber 20 along the walls 22 and floor 26. The barrier wall 70 between the heat source 60 and inner chamber 20 is comprised of solid wall portions 72 and perforated plate portions 74 to allow for thermal convection. A generator 52 may be in electrical communication with the furnace 60 through junction box 68.

In operation, mattresses 81 may be placed onto cart 80 for processing. The v-groove castors 82 are aligned with angles 56 and the cart 80 is rolled into the processer 10, Two or more of such carts 80 may be placed into the processor 10 at one time. This floors 44 are closed and the heat source 60 heats the mattresses 81 to a desired temperature for a desired period of time. Upon completion, the doors 44 are opened and carts 80 removed. The processed mattresses 81 (or other furniture) are now pathogen and bug free and are ready for continued use.

Although the present invention has been described with reference to preferred embodiments, workers skilled in the art will recognize changes may be made in form and detail without departing from the spirit and scope of the invention.

What is claimed is:

1. A portable mattress and upholstery processor comprising:
an outer enclosure having side walls, a ceiling, and a floor joined to define an outer chamber;
an inner enclosure having side walls, a ceiling, and a floor joined to define an inner chamber, the inner enclosure being joined inside the outer chamber;
doors being joined to the side walls of the outer and inner enclosures and attached by means of hinges;
raised angles joined to the floor of the inner enclosure, the angles running from the doors to the wall opposite the doors, the angles sized and adapted to receive and guide v-groove casters;
a light source sized and adapted to illuminate the inner chamber;
tracks sized and adapted to receive the forks of a forklift, joined to the floor of the outer chamber;
carts sized and adapted for transport of mattresses and furniture from an area outside the outer enclosure to the inner chamber, the carts having v-groove casters; and
a heat source located adjacent a side wall within the inner chamber, the heat source in convective thermal communication with the inner chamber.

2. A portable mattress and upholstery processor composing:
an enclosure having side walls, a ceiling, and a floor joined to define a chamber;
at least one door being located on a side wall of the enclosure and hingedly attached to the side wall to provide access from an area outside the enclosure to the chamber;
guides joined to the floor of the enclosure, the guides running from the door to the wall opposite the door, the guides sized and adapted to receive and direct casters;
at least one cart sized and adapted for transport of mattresses and furniture from an area outside the enclosure to the chamber, the cart having casters;
at least one mattress positioned on the cart; and
a heat source, the heat source in convective thermal communication with the mattress within the chamber.

3. The device of claim 2 in which the guides are raised angles sized and adapted to receive and direct v-groove casters and the casters of the cart being v-groove casters.

4. The device of claim 2 in which the enclosure is comprised of
an outer enclosure and an inner enclosure, the inner enclosure being Joined inside the outer enclosure;
brackets being attached to and located between the outer and inner enclosures;
insulation being secured about the brackets and being located between the outer and inner enclosures.

5. The device of claim 2 in which view ports are located on the side walls of the enclosure, the view ports providing visual access from an area outside the enclosure to the chamber.

6. The device of claim 2 including a light source sized and adapted to illuminate the chamber.

7. The device of claim 5 in which the light source is in electrical communication with a generator.

8. The device of claim 2 In which the heat source is in electrical communication with a generator.

9. The device of claim 2 in which the heat source is a furnace.

10. The device of claim 9 in which the furnace is located adjacent a side wall within the chamber, the heat source having:
heating elements;
thermocouples sized and adapted to regulate the temperature of the inner chamber; and
temperature probes sized and adapted for emergency shut-off of the heat source.

11. The device of claim 9 in which a barrier wall is positioned adjacent to and enclosing the furnace, in connection with the chamber along the walls, floor and ceiling, the barrier walls being comprised of Solid wall portions and perforated plate portions.

12. The device of claim 10 in which the emergency shut-off of the heat source occurs at a temperature equal to or greater than 350 degrees Fahrenheit.

13. The device of claim 2 containing racks within the chamber, the racks sized and adapted for placement of mattresses and furniture.

14. The device of claim 13 in which mattresses and furniture are disposed on the racks to define spaces, the spaces between the mattresses and furniture are sized and adapted to allow for thermal convection therebetween.

15. A portable mattress and upholstery processor comprising:
an enclosure having side walls, a ceiling, and a floor joined to define a chamber; at least one mattress within the chamber;
a heat source located within the chamber, the heat source in convective thermal communication with the mattress within the chamber; and
tracks sized and adapted to receive the forks of a forklift, joined to the floor of the chamber.

16. The device of claim 15 in which the enclosure is comprised of
an outer enclosure and an inner enclosure, the inner enclosure being joined inside the outer enclosure;
brackets being attached to and located between the outer and inner enclosures; insulation being secured about the brackets and being located between the outer and inner enclosures.

17. The device of claim 15 having at least one door being located on a side wall of the enclosure and hingedly attached to the side wall to provide access from an area outside the enclosure to the chamber.

18. The device of claim 15 in which view ports are located on the side walls of the enclosure, the view ports providing visual access from an area outside the enclosure to the chamber.

19. The device of claim 15 in which the heat source is a furnace.

20. The device of claim 15 in which a barrier wall is positioned adjacent to and enclosing the furnace, in connection with the chamber along the walls, floor and ceiling, the barrier walls being comprised of solid wall portions and perforated plate portions.
